(19) United States
(12) Patent Application Publication
(10) Pub. No.: US 2011/0157060 A1
(43) Pub. Date: Jun. 30, 2011

(54) TOUCH-CONTROL SYSTEM, DUAL-INPUT TOUCH-CONTROL SYSTEM AND TOUCH-DETECTING METHOD

(75) Inventors: Herng-Ming Yeh, Taoyuan County (TW); Yi-Ta Chen, Taoyuan County (TW)

(73) Assignee: Higgstec Inc., Taoyuan County (TW)

(21) Appl. No.: 12/980,709

(22) Filed: Dec. 29, 2010

(30) Foreign Application Priority Data
Dec. 29, 2009 (TW) 098145485

(51) Int. Cl. G06F 3/041

(52) U.S. Cl. 345/173

(57) ABSTRACT

A touch-control system, dual-input touch-control system and a relevant touch-detecting method transmit a pre-generated identification signal through an indicating device to a touch screen and its control unit. Through the identification of the identification signal, those input signals not relevant to the identification signal will be filtered as noises, thereby prevents error touches of human finger or palm when using the indicating device.

### CROSS-REFERENCES TO RELATED APPLICATIONS

This non-provisional application claims priority under 35 U.S.C. §119(a) on Patent Application No. 98145485 filed in Taiwan, R.O.C. on Dec. 29, 2009, the entire contents of which are hereby incorporated by reference.

### BACKGROUND OF THE INVENTION

1. Field of Invention

The present invention relates to a touch-control panel, and in particular, to a touch-control system, a dual-input touch-control system and a touch-detecting method.

2. Related Art

Nowadays, resistive-type and capacitive-type touch screens are the two main streams in the market; in which, the resistive-type includes four-wire resistive type, five-wire resistive type, six-wire, seven-wire or nine-wire resistive type, while the capacitive-type includes surface capacitive type (Surface Capacitance Touch Screen, SCT Screen) and projective capacitive type (Projective Capacitance Touch Screen, PCT Screen). The projective capacitive touch screen is also known as digital touch-control technology; on the other hand, the resistive-type and surface capacitive touch screen are also known as touch-control technologies.

Among these touch-control technologies, five-wire resistive type and five-wire capacitive type touch screens are the most popular ones. Refer to FIG. 1, which is a schematic view of a conventional five-wire resistive touch screen. Resistance chain XL is located at the left side of X axis, while resistance chain XR is located at the right side of X axis. Resistance chain YU is located at the upper side of Y axis and resistance chain YD is located at the bottom side of Y axis. The four resistance chains connect with four voltage input ends N1, N2, N3 and N4; a signal detecting end S is adapted to detect touch signals. Since the five-wire resistive touch screen uses a dual-layer electrode structure, the signal detecting end S will detect the voltage at an object contact point when an object (e.g. a human finger) contacts an upper thin-film conductive layer of the five-wire resistive touch screen so that the two electrode layers are electrically connected with each other and a control module may calculate the coordinates of the object contact point.

Please refer to FIG. 2, which is a schematic view of a control module in a conventional five-wire resistive touch screen. The control unit 10 connects with voltage input ends N1, N2, N3 and N4 and with a signal detecting end S to control output voltages supplied to the voltage input ends N1, N2, N3 and N4. The signal detecting end S is used to detect the changes of output voltages so that the coordinates of the object contact point may be calculated.

Such conventional touch-detecting method may detect an object contact point to calculate the coordinates. However, some problems occur when using an indicating device (e.g. a touch-control pen) as an input media. For example, when using the indicating device, if the user's finger or palm also touches the touch screen, touch errors on the touch screen will be followed with wrong calculated coordinates. Such problem is much more severe on a large scale touch screen.

To resolve these problems, a solution aiming at the resistive-type touch screen is provided with the processing on the spacers of the touch screen. Please refer to FIG. 3, which is a cross-sectional explanatory view of a conventional five-wire resistive touch screen with a finger pressing thereon. When the finger 18 presses a thin-film conductive layer 12 of the touch screen, the thin-film conductive layer 12 will deform at the intervals of spacers 14 and electrically connect with a conductive layer 16. A pressing force given by a finger is about 20±5 grams, while a palm gives a 80˜90 grams of pressing force and a touch-control pen gives 150˜350 grams. A general resistive-type touch screen may have a poor design on the spacers 14 so that the conductive layers may contact with each other under a pressing force greater than 20 grams. Accordingly, either the user's palm or the touch-control pen may initiate a touch operation and lead to error touches. The solution for such case is to increase the density of the spacers 14, thereby raising the initiating pressure to more than 150 grams.

However, such solution resolves only the palm's error touch issue; the force required for a finger to initiate a touch operation is also increased, which causes user's inconveniences. Therefore, it is necessary to develop an advanced touch-detecting technology for the indicating device without error touch issues.

### SUMMARY OF THE INVENTION

Accordingly, the present invention provides a touch-control system applied to a touch screen having plural voltage input ends and a signal detecting end. The touch-control system includes a control unit and an indicating device. The control device connects with the voltage input ends and the signal detecting end of the touch screen; the control device generates an identification signal and supplies an output voltage to the signal detecting end. The indicating device receives the identification signal and sends the identification signal to the touch screen; wherein the control unit detects the change of the output voltage through the voltage input end and the transmission of the identification signal to calculate a contact coordinate.

In an embodiment of the present invention, a dual-input touch-control system is applied to a touch screen having plural voltage input ends and a signal detecting end. The dual-input touch-control system includes a first control unit, a second control unit and an indicating device. The first control unit connects with the voltage input ends and the signal detecting end of the touch screen; the first control unit supplies an output voltage to the voltage input end, and detect the change of the output voltage through the signal detecting end to calculate an object contact coordinate. The second control unit connects with the first control unit and with the voltage input ends and the signal detecting end of the touch screen. The second control unit generates an identification signal and supplies the output voltage to the signal detecting end. The indicating device connects with the second control unit to receive the identification signal and transmit the identification signal to the touch screen when the touch screen is touched; wherein, the second control unit detects the change of the output voltage through the voltage input ends and the transmission of the identification signal, and calculates an indicator contact coordinate.

According to another embodiment of the present invention, a dual-input touch-detecting method includes the following steps. Perform a first touch-detecting mode to calculate a first coordinate where an object contacts the touch screen. Generate an identification signal through an indicating device; input the identification signal to the touch screen when the indicating device contacts the touch screen. Perform a second touch-detecting mode to detect the identification signal and calculate a second coordinate where the indicating device contacts the touch screen. Sequentially perform the first touch-detecting mode and the second touch-detecting mode. When receiving the identification signal, reduce the duty cycle distributed to the first touch-detecting mode, and increase the duty cycle distributed to the second touch-detecting mode.

According to another embodiment of the present invention, a dual-input touch-detecting method includes the following steps. Perform a first touch-detecting mode to calculate a first coordinate where an object contacts the touch screen. Generate an identification signal through an indicating device; input the identification signal to the touch screen when the indicating device contacts the touch screen. Perform a second touch-detecting mode to detect an identification signal and calculate a second coordinate where the indicating device contacts the touch screen. Perform the first touch-detecting mode. Terminate the first touch-detecting mode and perform the second touch-detecting mode when receives a switch command. Terminate the second touch-detecting mode and perform the first touch-detecting mode when receives the switch command during performing the second touch-detecting mode.

Preferred embodiments of the present invention and efficacies thereof will be illustrated in detail below with the accompanying drawings.

### BRIEF DESCRIPTION OF THE DRAWINGS

The present invention will become more fully understood from the detailed description and accompanying drawing given herein below for illustration only, and thus are not limitative of the present invention, and wherein:

FIG. 1 is a schematic view of a conventional five-wire resistive touch screen;

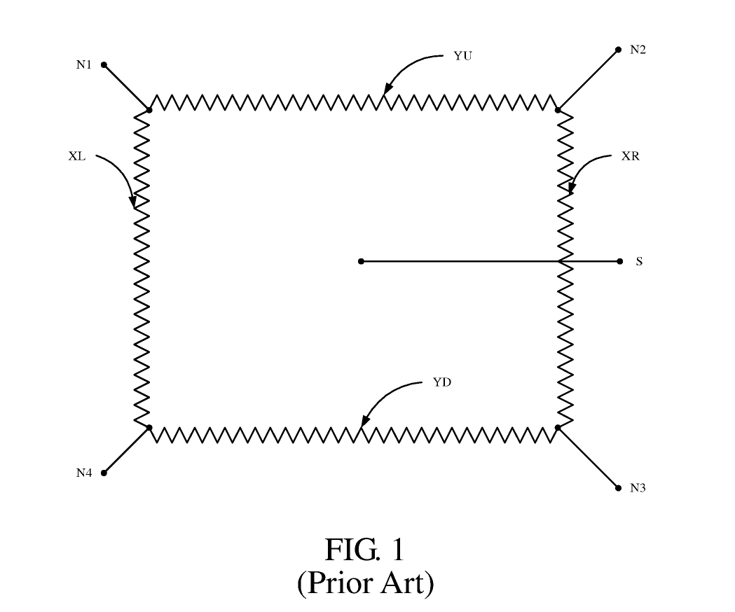

FIG. 2 is a schematic view of a control module in a conventional five-wire resistive touch screen;

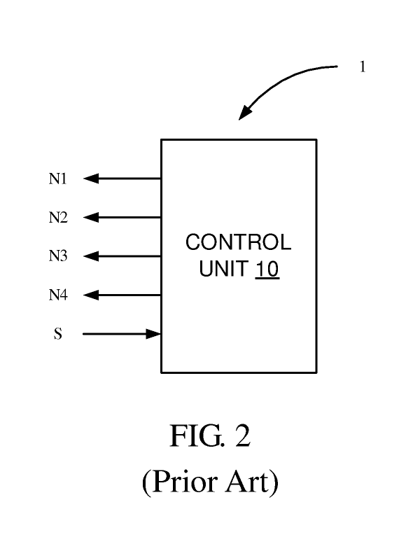

FIG. 3 is a cross-sectional explanatory view of a conventional five-wire resistive touch screen with a user's finger pressing thereon;

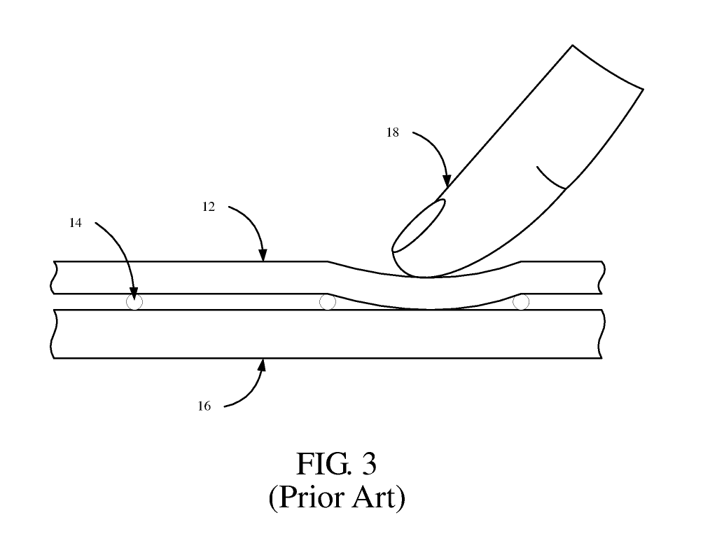

FIG. 4 is a schematic view of a touch-detecting module for indicating device according to an embodiment of the present invention;

FIG. 5 is a system block diagram of a dual-input touch-control system for finger and indicating device according to an embodiment of the present invention;

FIG. 6 is a system block diagram of another dual-input touch-control system for finger and indicating device according to another embodiment of the present invention;

FIG. 7 is a system block diagram of another dual-input touch-control system for finger and indicating device according to another embodiment of the present invention;

FIG. 8 is a flow chart of a dual-input touch-detecting method according to an embodiment of the present invention; and

FIG. 9 is a flow chart of another dual-input touch-detecting method according to another embodiment of the present invention.

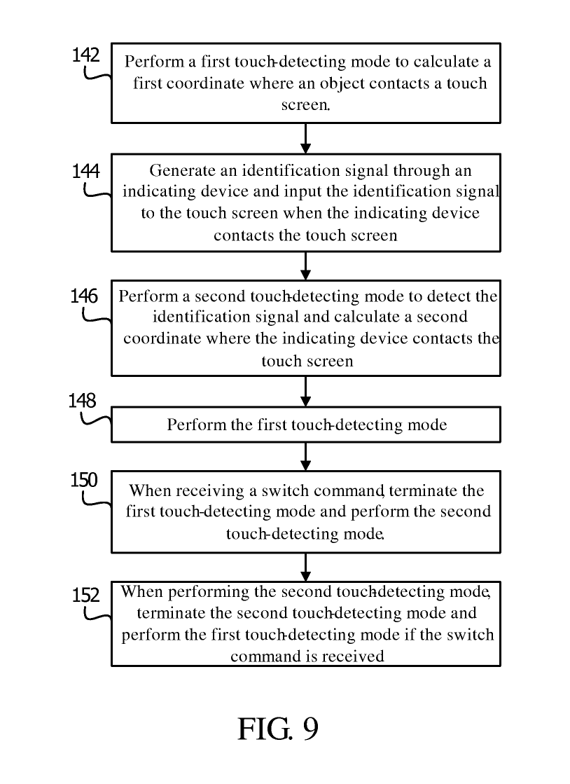

### DETAILED DESCRIPTION OF THE INVENTION

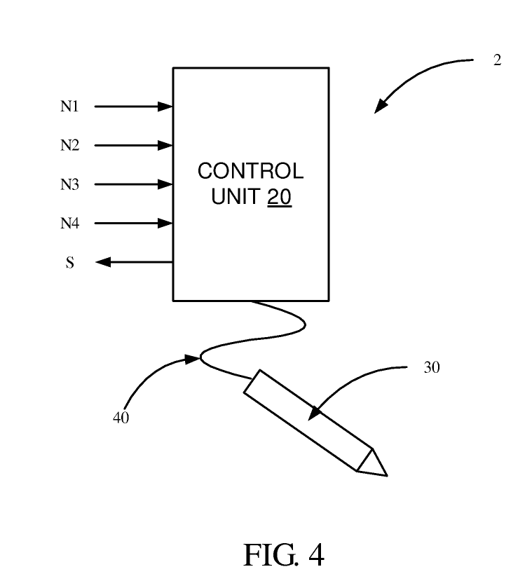

First of all, please refer to FIG. 4, which is a schematic view of a touch-detecting module 2 for detecting an indicating device according to an embodiment of the present invention. The touch-detecting module 2 includes a control unit 20, an indicating device 30 and a transmission line 40. The control unit 20 electrically connects with a touch screen (not shown) through voltage input ends N1, N2, N3 and N4 and a signal detecting end S. The control unit 20 generates an identification signal, and control to supply an output voltage to the signal detecting end S. The control unit 20 detects the change of the output voltage through the voltage input ends N1, N2, N3 and N4 and the transmission of the identification signal, and calculates a coordinate where the identification signal transmits. The indicating device 30 receives the identification signal and transmits the identification signal to the touch screen.

There are many types of identification signal practical for the embodiments of the present invention; as long as the signal is identificational, and is AC (alternating current) type rather than a DC (Direct Current) signal. For example, the identification signal is selected from the group consisting of an AC signal, a sine wave signal, a frequency-modulated sine wave signal, an amplitude-modulated sine wave signal, a square wave signal, a frequency-modulated square wave signal an amplitude-modulated square wave signal and any combination of the signals mentioned above.

Namely, the identification signal generated from the control unit 20 is sent through the transmission line 40 to the indicating device 30. Since the identification signal is an AC signal, the touch screen may sense the identification signal through the four voltage input ends N1, N2, N3 and N4 when the indicating device 30 contacts the touch screen. Since the indicating device 30 is insulated from the touch screen when touching the touch screen, the signal is transmitted to the electrode layer of the touch screen through capacitance effect. Afterwards, the control unit 20 calculates an indicator contact coordinate where the indicating device 30 contacts through the voltage difference between the signal detecting end S and the four voltage input ends N1, N2, N3 and N4. The touch-detecting module 1 detects a touch point according to whether the identification signal is detected so non-identification signal types of touch operations will be ignored. Therefore, the error touches from the user's palm or other objects not subject to the indicating device 30 can be excluded.

Aside from the resistive-type touch screen mentioned above, what disclosed in the embodiments of the present invention may be applied on the capacitive-type touch screen, either the surface capacitive type or the projective capacitive type.

In addition, a pressure sensor may be implemented inside the indicating device 30 to facilitate detection of three dimensional coordinates. The pressure sensor detects the pressure that the indicating device generates when touching the touch screen, feedbacks to the control unit 20 for the calculation of a coordinate on the third dimension (Z axis), thereby achieving a three dimensional detecting function. The aforesaid feedback operation is performed through the transmission line 40.

In the embodiment shown in FIG. 4, the control unit 20 and the indicating device 30 may complete a touch control function without being interfered by palm's error touches. Aside from solely utilizing the indicating device 30 to input touch operation, a dual-input touch-control system may be used. Namely, the conventional object (finger) touch detection may be integrated with the touch control of the above-mentioned indicating device, thereby allowing different users to select a favorable type of touch operations.

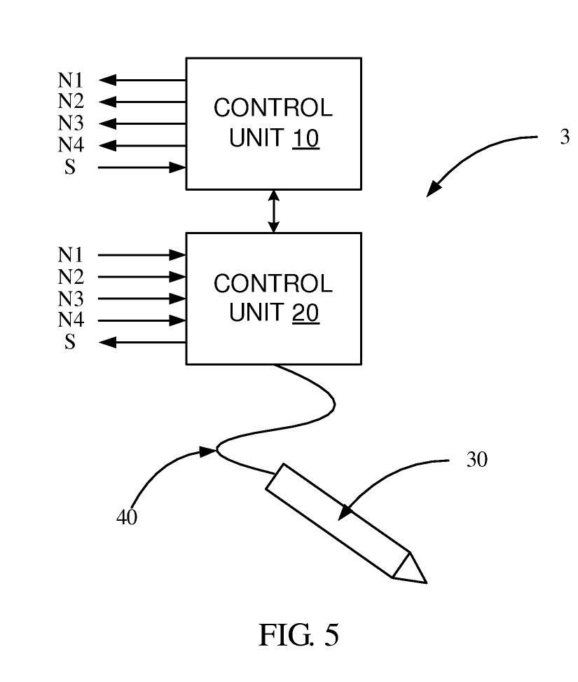

Please refer to FIG. 5, which is a system block diagram of a dual-input touch-control system 3 for both the finger and indicating device according to an embodiment of the present invention. The control unit 10 (the first control unit) may realize the object touch detection and coordinate calculations of the five wire resistive-type touch screen; while the control unit 20 (the second control unit) may realize object touch detection and coordinate calculations of the indicating device.

The control unit 10 connects with the touch screen through the voltage input ends N1, N2, N3 and N4 and the signal detecting end S, and controls an output voltage supplied to the voltage input ends N1, N2, N3 and N4. The control unit 10 also detects the changes of the output voltage through the signal detecting end S and calculates an object contact coordinate where the object contacts. On the other hand, the control unit 20 connects with the touch screen and the first control unit 10, generates an identification signal and controls the output voltage supplied to the signal detecting end S; through the voltage input ends N1, N2, N3 and N4, the control unit 20 detects the changes of the output voltage and the transmission of the identification signal to calculate the coordinate where the identification signal is transmitted. The indicating device 30 electrically connects with the control unit 20 through the transmission line 40, receives the identification signal and transmits the identification signal to the touch screen.

Similarly, the control unit 20 may detect that the indicating device 30 contacts the touch screen, and be capable of calculating the position where the indicating device 30 contacts the touch screen. Through the transmission of the identification signal, a touch operation may be determined with other touch operation not relevant to the identification signal being excluded. To achieve that, the control unit 20 may set an identification mechanism specifically for identifying the identification signal. For example, a sine wave signal at a certain frequency may be used as the identification signal. In such case, an additional wave filter may be used to filter a voltage signal of the sine wave identification signal. Subsequently, use the voltage values of the four voltage input ends N1, N2, N3 and N4 when detecting the identification signal, to calculate the coordinate where the identification signal is generated, namely the coordinate with the indicating device 30 contacts the touch screen.

In actual practice, the control unit 10 and the control unit 20 respectively determine a touch from an object (finger) and a touch from the indicating device, which are not able to work synchronously. Therefore, certain switching mechanism should be further designed.

The first switching mechanism is to automatically detect the identification signal sent by the indicating device 30. Regularly, a time division method is used to switch subsequently between detecting by the control unit 10 (a first touch-detecting mode) and detecting by the control unit 20 (a second touch-detecting mode). When detecting a touch from an object, the control unit 10 will serve as the main controller; in such period the control unit 20 will be distributed with a lower duty cycle, yet the control unit 10 will be distributed with a higher duty cycle. For example, the control unit 10 may have a 90% duty cycle while the control unit 20 has only 10% duty cycle. On the other hand, if the identification signal from the indicating device 30 is detected, the control unit 20 will serve as the main controller; in such period, the control unit 10 has a less duty cycle and the control unit 20 will have a higher duty cycle. For example, the control unit 10 may have only 10% duty cycle, while the control unit 20 may have 90% duty cycle. If the object and the indicating device 30 touches/contacts the touch screen simultaneously, the contact of the indicating device 30 will be considered as the priority; namely, the control unit 20 will be distributed with a higher duty cycle.

The automatic switching mechanism mentioned above may be managed by the control unit 10 or the control unit 20. Such automatic switching mechanism may have various practical approaches so is not further described in detail.

The second switching mechanism is to manually switch between the detecting of the control unit 10 and the control unit 20. In order to switch manually, a switch element may be used to input a switch command. As long as the switch command is received, the detecting may be switched from the first touch-detecting mode to the second touch-detecting mode, or switched in the opposite.

The above-mentioned descriptions disclose a dual-input touch-control system that is capable of switching between two modes of detecting an object and detecting an indicating device.

Furthermore, a dual-input touch-control system may also be used to detect contact coordinates in three dimensions by installing a pressure sensor on the indicating device.

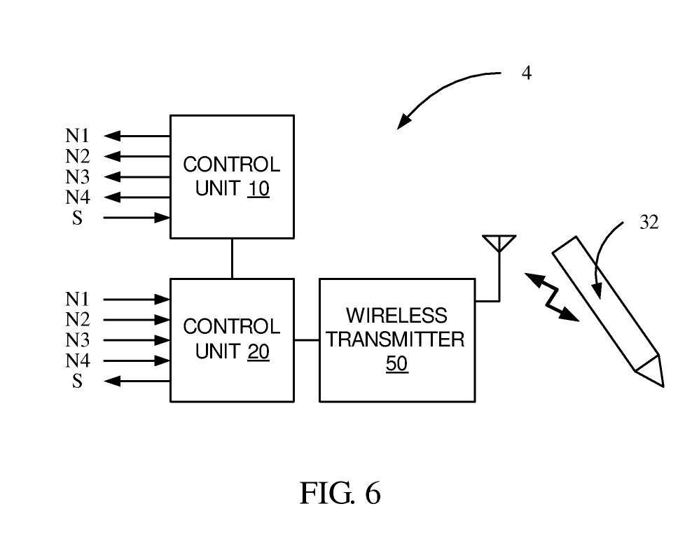

Aside from the wired design illustrated in FIG. 4, the indicating device 30 may also perform with wireless signal communication. Please refer to FIG. 6, which is a system block diagram of another dual-input touch-control system 4 for finger and indicating device according to another embodiment of the present invention. Comparing to FIG. 5, FIG. 6 is a wireless transmitter 50 and omits the transmission line 40. Moreover, the indicating device 32 in FIG. 6 must include a wireless receiver and the relevant power supply (both not shown).

The wireless transmitter 50 electrically connects with the control unit 20, modulates the identification signal generated from the control unit 20 and transmits outwardly as a wireless signal. The wireless receiver inside the indicating device 30 receives the wireless signal sent from the wireless transmitter 50, modulates the wireless signal and transmitted through the indicating device 30 the touch screen.

A coil (not shown) may be installed to surround a perimeter of the touch screen and electrically connect with the wireless transmitter 50, thereby may be used as an antenna for the wireless transmitter 50 to transmit the wireless signal.

A sensing coil (not shown) may be installed on the circuit board of the indicating device 30 and connected with the wireless receiver. The sensing coil may be used as the antenna of the wireless receiver and generate an operation voltage for the indicating device when the wireless receiver receives a wireless signal in a short range. Such approach is very similar to the operating principles of radio frequency identification tag. Since the indicating device 30 does not need electricity unless it contacts the touch screen, and it needs only a very low power, such wireless sensing type of power supply may greatly reduce the consuming of electrical components.

Similarly, the indicating device 30 may have a pressure sensor (not shown) installed thereon; only sensed results of the pressure sensor(s) need to be sent back. There are two methods to send back the sensed results of the pressure sensor(s). The first is to be sent through the indicating device 30 to the touch screen; the second is to be sent wirelessly. In the first method, aside from the identification signal, the indicating device 30 also needs to modulate the sensed results of the pressure sensor, so as to send the modulated sensed results through the identification signal to the touch screen and subsequently demodulated by the control unit 20. Thus, the control unit 20 would have to include such demodulation capability. The indicating device may include a signal modulator and a pressure sensor (both not shown); wherein the pressure sensor detects a pressure signal when the indicating device contacts the touch screen, and transmits to the signal modulator for signal modulation. Such modulated pressure signal will be transmitted to the control unit through the touch screen. The control unit would need to further include a signal demodulator, which demodulates the modulated pressure signal transmitted from the touch screen; and then the control units calculates a coordinate of a third dimension. In general, analog or digital modulation is a mature technology, which needs not to further describe in detail.

The second method is to perform a wireless bidirectional communication; namely, both the control unit 20 and the indicating device 30 need to be equipped with a wireless transceiver respectively.

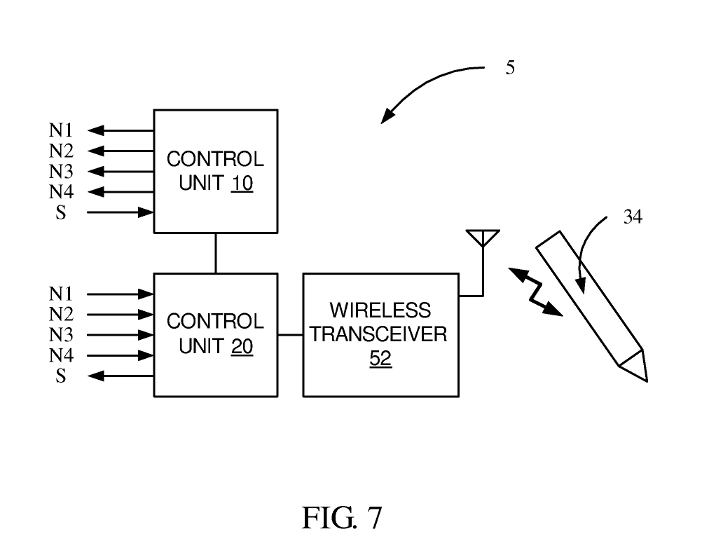

Please refer FIG. 7, which is a system block diagram of another dual-input touch-control system 5 for finger and indicating device according to another embodiment of the present invention; this embodiment discloses that both the control side and the indicating device are equipped with a wireless transceiver respectively. Comparing to FIG. 6, FIG. 7 shows a control unit 10 (the first control unit), a wireless transceiver 52 (the first wireless transceiver) used as a data transmission interface of the control unit 20 (the second control unit), and another wireless transceiver (the second wireless transceiver) installed inside the indicating device 30. Since both the ends are implemented with the wireless transceivers, the signals generated from the indicating device 30 may be transmitted through the wireless transceiver 52 to the control unit 20. Namely, the aforesaid transmission of the sensed results from the pressure sensor on the indicating device 30 may be realized, so as to embody a coordinate detection in three dimensions.

In short, the touch-control system needs to further include a first wireless transceiver and a second wireless transceiver (both not shown). The first wireless transceiver connects with the control unit, modulates the identification signal generated from the control unit and transmits outwardly as a wireless signal. The second wireless transceiver connects with the indicating device, receives and demodulates the wireless signal and transmits to the touch screen through the indicating device; the second wireless transceiver modulates status information generated by the indicating device and transmits outwardly through the wireless signal. Correspondingly the indicating device may further include a pressure sensor. The pressure sensor connects with the second wireless transceiver, detects a pressure signal when the indicating device contacts the touch screen, and transmits the pressure signal outwardly through the second wireless transceiver; wherein the pressure signal is further transmitted through the wireless transceiver to the control unit for calculating a coordinate of a three dimension.

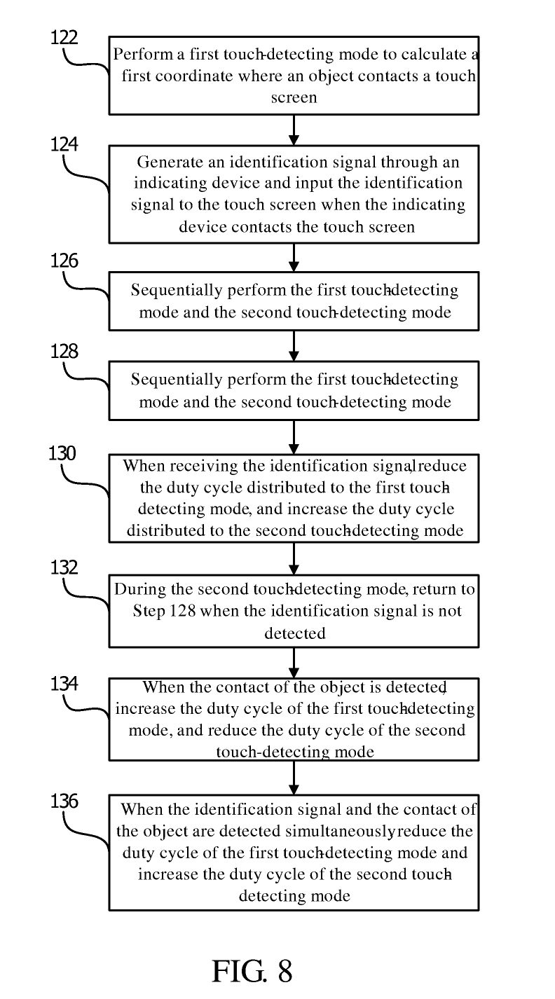

Next, please refer to FIG. 8, which is a flow chart of a dual-input touch-detecting method according to an embodiment of the present invention; what disclosed is a method of automatically switching the touch-detecting modes. The method includes the following steps.

Step 122: Perform a first touch-detecting mode to calculate a first coordinate where an object contacts a touch screen.

Step 124: Generate an identification signal through an indicating device and input the identification signal to the touch screen when the indicating device contacts the touch screen.

Step 126: Perform a second touch-detecting mode to detect the identification signal and calculate a second coordinate where the indicating device contacts the touch screen.

Step 128: Sequentially perform the first touch-detecting mode and the second touch-detecting mode.

Step 130: When receiving the identification signal, reduce the duty cycle of the first touch-detecting mode, and increase the duty cycle of the second touch-detecting mode.

Step 132: During the second touch-detecting mode, return to Step 128 when the identification signal is not detected.

Step 134: When the contact of the object on the touch screen is detected, increase the duty cycle of the first touch-detecting mode, and reduce the duty cycle of the second touch-detecting mode.

Step 136: When the identification signal and the contact of the object are detected simultaneously, reduce the duty cycle of the first touch-detecting mode and increase the duty cycle of the second touch-detecting mode.

Furthermore, the method may include the follow step: After a preset duration without receiving the identification signal, return to the step of performing the first touch-detecting mode and the second touch-detecting mode.

The method may include the follow step: Calculate a third dimension coordinate according to a pressure signal generated from the indicating device when the indicating device contacts the touch screen.

Please refer to FIG. 8, which is a flow chart of a dual-input touch-detecting method according to an embodiment of the present invention; what disclosed is a method of manually switching the touch-detecting modes. The method includes the following steps.

Step 142: Perform a first touch-detecting mode to calculate a first coordinate where an object contacts a touch screen.

Step 144: Generate an identification signal through an indicating device and input the identification signal to the touch screen when the indicating device contacts the touch screen.

Step 146: Perform a second touch-detecting mode to detect the identification signal and calculate a second coordinate where the indicating device contacts the touch screen.

Step 148: Perform the first touch-detecting mode.

Step 150: When receiving a switch command, terminate the first touch-detecting mode and perform the second touch-detecting mode.

Step 152: When performing the second touch-detecting mode, terminate the second touch-detecting mode and perform the first touch-detecting mode if the switch command is received.

In addition, the method may include the following step: Calculate a third dimension coordinate according to a pressure signal generated from the indicating device when the indicating device contacts the touch screen.

While the present invention has been described by the way of example and in terms of the preferred embodiments, it is to be understood that the invention need not to be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A touch-control system, applied to a touch screen having a plurality of voltage input ends and a signal detecting end, the touch-control system comprising:
a control unit, connecting with the voltage input ends and the signal detecting end of the touch screen, generating an identification signal and supply an output voltage to the signal detecting end; and
an indicating device, connecting with the control unit, receiving the identification signal and transmitting the identification signal to the touch screen when the indicating device contacts the touch screen;
wherein the control unit detects the change of the output voltage through the voltage input end and the transmission of the identification signal to calculate a contact coordinate.

2. The touch-control system according to claim 1, wherein the indicating device comprises:
a pressure sensor, detecting a pressure signal when the indicating device contacts the touch screen, and transmitting the pressure signal to the control unit for calculating a coordinate of a third dimension.

3. The touch-control system according to claim 1 further comprising:
a wireless transmitter, connecting with the control unit, modulating the identification signal generated from the control unit and transmitting outwardly as a wireless signal; and
a wireless receiver, connecting with the indicating device, receiving and modulating the wireless signal, and transmitting through the indicating device to the touch screen.

4. The touch-control system according to claim 3, wherein the indicating device comprises:
a signal modulator; and
a pressure sensor, detecting a pressure signal when the indicating device contacts the touch screen, and transmitting to the signal modulator for signal modulation.

5. The touch-control system according to claim 4, wherein the control unit comprises:
a signal demodulator, demodulating the modulated pressure signal transmitted from the touch screen for the control unit to calculate a coordinate of a third dimension.

6. The touch-control system according to claim 3, wherein the indicating device comprises:
a sensing coil, installed on a circuit board of the indicating device and connected with the wireless receiver, wherein the sensing coil operates as the antenna of the wireless receiver and generates an operation voltage for the indicating device when the wireless receiver receives a wireless signal in a short range.

7. The touch-control system according to claim 1 further comprising:
a first wireless transceiver, connecting with the control unit, modulating the identification signal generated from the control unit and transmitting outwardly as a wireless signal; and
a second wireless transceiver, connecting with the indicating device, receiving and demodulating the wireless signal and transmitting to the touch screen through the indicating device, the second wireless transceiver modulating status information generated by the indicating device and transmitting outwardly through the wireless signal.

8. The touch-control system according to claim 7, wherein the indicating device comprises:
a pressure sensor, connecting with the second wireless transceiver, detecting a pressure signal when the indicating device contacts the touch screen, and transmitting the pressure signal outwardly through the second wireless transceiver, wherein the pressure signal is further transmitted through the wireless transceiver to the control unit for calculating a coordinate of three dimension.

9. A dual-input touch-control system, applied to a touch screen having a plurality of voltage input ends and a signal detecting end, the dual-input touch-control system comprises:
a first control unit, connecting with the voltage input ends and the signal detecting end of the touch screen, supplying an output voltage to the voltage input ends, detecting the change of the output voltage through the signal detecting end and calculating an object contact coordinate;
a second control unit, connecting with the first control unit and with the voltage input ends and the signal detecting end of the touch screen, generating an identification signal and supplying the output voltage to the signal detecting end; and
an indicating device, connecting with the second control unit, receiving the identification signal and transmitting the identification signal to the touch screen when the indicating device contacts the touch screen;
wherein the second control unit detects the change of the output voltage through the voltage input ends and the transmission of the identification signal to calculate an indicator contact coordinate.

10. The dual-input touch-control system according to claim 9, wherein the indicating device comprises:
a pressure sensor, detecting a pressure signal when the indicating device contacts the touch screen, and transmitting the pressure signal to the second control unit for calculating a coordinate of a third dimension.

11. The dual-input touch-control system according to claim 9 further comprising:
a wireless transmitter, connecting with the second control unit, modulating the identification signal generated from the second control unit and transmitting outwardly as a wireless signal; and
a wireless receiver, connecting with the indicating device, receiving and modulating the wireless signal, and transmitting through the indicating device to the touch screen.

12. The dual-input touch-control system according to claim 11, wherein the indicating device comprises:
a signal modulator; and
a pressure sensor, detecting a pressure signal when the indicating device contacts the touch screen, and transmitting to the signal modulator for signal modulation.

13. The dual-input touch-control system according to claim 12, wherein the second control unit comprises:
a signal demodulator, demodulating the modulated pressure signal transmitted from the touch screen for the control unit to calculate a coordinate of a third dimension.

14. The dual-input touch-control system according to claim 12, wherein the indicating device comprises:
a sensing coil, installed on a circuit board of the indicating device and connected with the wireless receiver, wherein the sensing coil operates as the antenna of the wireless receiver and generates an operation voltage for the indicating device when the wireless receiver receives a wireless signal in a short range.

15. The dual-input touch-control system according to claim 9 further comprising:
a first wireless transceiver, connecting with the second control unit, modulating the identification signal generated from the second control unit and transmitting outwardly as a wireless signal; and
a second wireless transceiver, connecting with the indicating device, receiving and demodulating the wireless signal and transmitting to the touch screen through the indicating device, the second wireless transceiver modulating status information generated by the indicating device and transmitting outwardly through the wireless signal.

16. The dual-input touch-control system according to claim 15, wherein the indicating device comprises:
a pressure sensor, connecting with the second wireless transceiver, detecting a pressure signal when the indicating device contacts the touch screen, and transmitting the pressure signal outwardly through the second wireless transceiver, wherein the pressure signal is further transmitted through the wireless transceiver to the second control unit for calculating a coordinate of three dimension.

17. The dual-input touch-control system according to claim 9 further comprising:
a switch element, connecting with the first control unit and the second control unit, and switching between detecting the contact of the object by the first control unit and detecting the contact of the indicating device by the second control unit.

18. A dual-input touch-detecting method, comprising the steps of:
performing a first touch-detecting mode to calculate a first coordinate where an object contacts a touch screen;
generating an identification signal through an indicating device and input the identification signal to the touch screen when the indicating device contacts the touch screen;
performing second touch-detecting mode to detect the identification signal and calculate a second coordinate where the indicating device contacts the touch screen;
sequentially performing the first touch-detecting mode and the second touch-detecting mode; and
when receiving the identification signal, reducing the duty cycle of the first touch-detecting mode, and increasing the duty cycle of the second touch-detecting mode.

19. The touch-detecting according to claim 18 further comprising the step of:
after a preset duration without receiving the identification signal, returning to the step of performing the first touch-detecting mode and the second touch-detecting mode.

20. The touch-detecting according to claim 18 further comprising the step of:
when the object contacts the touch screen without receiving the identification signal, increasing the duty cycle of the first touch-detecting mode, and reducing the duty cycle of the second touch-detecting mode.

21. The touch-detecting according to claim 18 further comprising the step of:
when the identification signal and the contact of the object are detected simultaneously, reducing the duty cycle of the first touch-detecting mode and increasing the duty cycle of the second touch-detecting mode.

22. The touch-detecting according to claim 18 further comprising the step of:
calculating a third dimension coordinate according to a pressure signal generated from the indicating device when the indicating device contacts the touch screen

23. A dual-input touch-detecting method, comprising the steps of:
performing a first touch-detecting mode to calculate a first coordinate where an object contacts a touch screen;
generating an identification signal through an indicating device and input the identification signal to the touch screen when the indicating device contacts the touch screen;
performing a second touch-detecting mode to detect the identification signal and calculate a second coordinate where the indicating device contacts the touch screen;
performing the first touch-detecting mode;
when receiving a switch command, terminating the first touch-detecting mode and performing the second touch-detecting mode; and
when performing the second touch-detecting mode, terminating the second touch-detecting mode and performing the first touch-detecting mode if the switch command is received.

24. The touch-detecting according to claim 23 further comprising the step of:
calculating a third dimension coordinate according to a pressure signal generated from the indicating device when the indicating device contacts the touch screen.
